(19) United States
(12) Patent Application Publication
(10) Pub. No.: US 2002/0144457 A1
(43) Pub. Date: Oct. 10, 2002

(54) Method and apparatus for removing thorns and foliage from stems of plants

(76) Inventor: William E. Harrison JR., Norman, OK (US)

Correspondence Address: DUNLAP, CODDING & ROGERS P.C., PO BOX 16370, OKLAHOMA CITY, OK, 73114, US

(21) Appl. No.: 09/832,055

(22) Filed: Apr. 10, 2001

(51) Int. Cl. A01C 1/00; A01G 1/00

(52) U.S. Cl. 47/1.01 R

(57) ABSTRACT

A method and apparatus for removing thorns and foliage from a plant stem. The apparatus includes an elongated body member having a passageway and a thorn removal member. The passageway of the elongated body member has a diameter greater than the diameter of the plant stem with its thorns allowing for passage of the plant stem and thorns through the passageway of the elongated body member. The thorn removal member has an opening sized to permit passage of the plant stem, while resisting passage of the thorns and foliage of the stem of the plant. The thorn removal member traverses the passageway of the elongated body member. As the stem of the plant is moved to and fro through the opening of the thorn removal member, at least a tip portion of the thorns is removed by the thorn removal member without damaging the stem of the plant.

### BACKGROUND OF THE INVENTION

1. Field of the Invention

The present invention relates generally to an apparatus for removing thorns and foliage from stems of plants, and more particularly, but not by way of limitation, to a method and apparatus for removing at least the tip portion of thorns and foliage from a stem of a plant without damaging the stem.

2. Description of Related Art

In the floral industry, stems of flowers, particularly roses, are typically cleared of thorns and spurious foliage before incorporating the flowers into a floral arrangement to prevent damage to the hands of a florist. Removing thorns and foliage from stems of plants is a time consuming and labor intensive process. Various methods and apparatus have heretofore been proposed and employed to remove thorns and foliage from stems of plants. However, problems often arise in the use of the prior art methods and apparatus in that either the thorns and foliage are not effectively removed or the xylem of the plant is damaged which results in premature decaying of the plant. Damage to plant stems during removal of thorns and foliage therefrom is a large, ongoing expense to the floral industry. Therefore, a need exists for improved methods and apparatus for removing at least the tip portion of thorns and foliage from a plant without damaging the plant's stem.

### BRIEF SUMMARY OF THE INVENTION

The present invention relates to a method and apparatus for removing thorns and foliage from a stem of a plant which does not suffer from the disadvantages of the prior art devices. The apparatus includes an elongated body member having a first end, a second end and a passageway extending there through. The passageway is provided with a diameter greater than the diameter of stem of the plant and thorns extending outwardly therefrom so that the stem of the plant is substantially unrestricted upon movement through the passageway of the elongated body member. The apparatus further includes a thorn removal member supported by the elongated body member such that the thorn removal member traverses a portion of the passageway in the elongated body member. The thorn removal member is provided with an opening therein which has a diameter less than the diameter of the passageway of the elongated body member. The opening in the thorn removal member is sized to permit passage of the stem of the plant there through, while resisting passage of the thorns and foliage on the stem of the plant so that at least a tip portion of the thorns and foliage on the stem of the plant are removed by the thorn removal member as the stem of the plant is moved to and fro through the opening in the thorn removal member.

An object of the present invention is to provide an effective and efficient method and apparatus for removing at least tip portions of thorns and foliage from a stem of a plant.

Another object of the present invention, while achieving the before-stated object, is to provide a method and apparatus for removing at least the tip portions of thorns and foliage from a stem of a plant without damaging the xylem of the plant.

Other objects, features and advantages of the present invention will become apparent from the following detailed description when read in conjunction with the accompanying drawings and appended claims.

### BRIEF DESCRIPTION OF THE SEVERAL VIEWS OF THE DRAWING

FIG. 1 is a perspective view of an apparatus for removing thorns and foliage from a stem of a plant constructed in accordance with the present invention.

FIG. 2 is a cross-sectional view of the apparatus of FIG. 1, illustrating removal of thorns from a stem of a plant.

FIG. 3 is a top plan view of the apparatus of FIGS. 1 and 2.

FIG. 4 is a cross-sectional view of another embodiment of an apparatus for removing thorns and foliage from a stem of a plant constructed in accordance with the present invention.

FIG. 5 is a top plan view of the apparatus of FIG. 4.

### DETAILED DESCRIPTION OF THE INVENTION

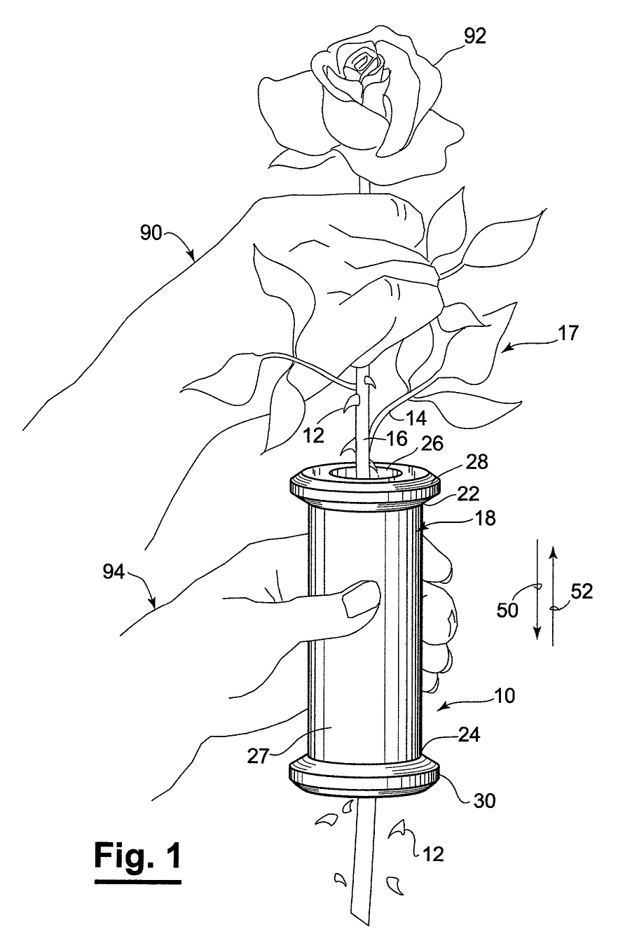

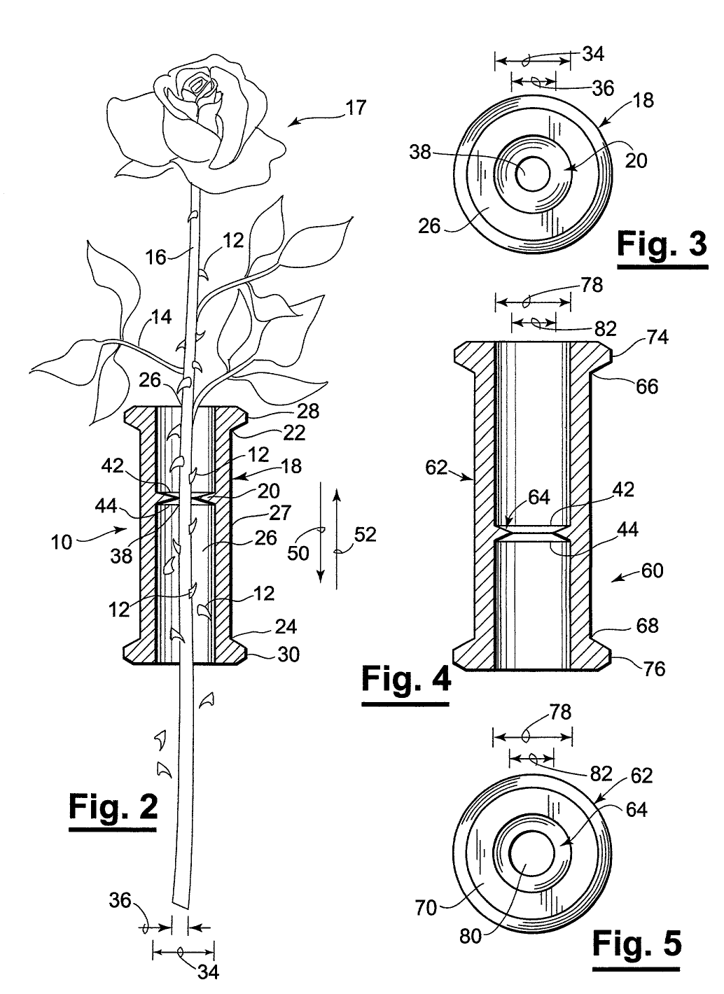

Referring now to the drawings, and more particularly to FIGS. 1 and 2, shown therein is an apparatus 10 for removing thorns 12 and foliage 14 from a stem 16 of a plant 17. The apparatus 10 includes an elongated body member 18 and a thorn removal member 20. The apparatus 10 may be fabricated of any suitable material, such as wood, ceramic, metal or a polymeric material. However, desirable results have been obtained when the apparatus 10 is constructed of a polymeric material, such as polyethylene or polypropylene.

The elongated body member 18 has a first end 22, a second end 24, a passageway 26 extending there between and an outer peripheral surface 27. The elongated body member 18 is further provided with a first outwardly extending shoulder 28 and a second outwardly extending shoulder 30. The first outwardly extending shoulder 28 is supported on the first end 22 of the elongated body member 18 and the second outwardly extending shoulder 30 is supported on the second end 24 of the elongated body member 18. The first outwardly extending shoulder 28 is disposed a distance from the second outwardly extending shoulder 30 so as to provide a hand grippable portion along the outer peripheral surface 27 of the elongated body member 18. Thus, an operator can grip the elongated body member 18 of the apparatus 10 with one hand thereby leaving the operator's other hand free to move the stem 16 of the plant 17 in a to and fro direction through the passageway 26 in the elongated body member 18 of the apparatus 10. The first outwardly extending shoulder 28 and the second outwardly extending shoulder 30 cooperate to stabilize the operator's hand on the outer peripheral surface 27 of the elongated body member 18 and prevent the slippage of the operator's hand along the outer peripheral surface 27 of the elongated body member 18 while holding the apparatus 10 during the removal of thorns 12 and foliage 14 from the stem 16 of the plant 17 via the thorn removal member 20.

The passageway 26 has a diameter 34 greater than the diameter of the stem 16 of the plant 17 and the thorns 12 extending outwardly therefrom so that the stem 16 of the plant 17 is substantially unrestricted upon passage through the passageway 26 of the elongated body member 18. The thorn removal member 20 is supported by the elongated body member 18 such that the thorn removal member 20 traverses the passageway 26 of the elongated body member 18. As shown in FIGS. 2 and 3, the thorn removal member 20 has an opening 38 therein which has a diameter 36 less than the diameter 34 of the passageway 26 of the elongated body member 18. The thorn removal member 20 is preferably disposed in the passageway 26 of the elongated body member 18 such that the opening 38 in the thorn removal member 20 is aligned with the centrally disposed elongated axis of the passageway 26 of the elongated body member 18 substantially as shown. It should also be understood that the thorn removal member 20 may traverse the passageway 26 of the elongated body member 18 anywhere along the length of the elongated body member 18.

As more clearly shown in FIGS. 2 and 3, the opening 38 in the thorn removal member 20 is sized and dimensioned to permit passage of the stem 16 of the plant 17, while resisting passage of the thorns 12 and spurious foliage 14 on the stem 16 of the plant 17, so that at least a tip portion of the thorns 12 or any spurious foliage 14 is removed by the thorn removal member 20 as the stem 16 of the plant 17 is moved in a to and fro direction as indicated by the directional arrows 50 and 52. The diameter 36 of the opening 38 of the thorn removal member 20 is less than the diameter 34 of the passageway 26 of the elongated body member 18. It should be understood that the opening 38 of the thorn removal member 20 can be circular, oval or any other shape in order to accept the stem 16 of the plant 17.

As shown in FIG. 2, the thorn removal member 20 has a first surface 42 and a second surface 44. Each of the first and second surfaces 42 and 44 of the thorn removal member 20 has a concave shape which enhance removal of the thorns 12 and spurious foliage 14 from the plant stem 16 without causing damage to the stem 16 of the plant 17, as the stem 16 of the plant 17 is moved in the to and fro direction 50 and 52 through the opening 38 in the thorn removal member 20. That is, the concave shape of the first and second surfaces 42 and 44 of the thorn removal member 20 direct the stem 16 of the plant 17 towards and into the opening 38 in the thorn removal member 20 when the stem 16 of the plant 17 is disposed into the passageway 26 of the elongated body member 18 of the apparatus 10. Further, because each of the first and second surfaces 42 and 44 of the thorn removal member 20 has a concave shape, the stem 16 of the plant 17 can be inserted into the apparatus 10 for removal of at least the tip portion of the thorns 12 and spurious foliage 14 via either the first end 22 or the second end 24 of the elongated body member 18.

Referring now to FIGS. 4 and 5, another embodiment of a thorn removal apparatus 60 is shown. The thorn removal apparatus 60 is similar to the thorn removal apparatus 10 herein before described except as described hereinafter. That is the thorn removal apparatus 60 is provided with an elongated body member 62 and a thorn removal member 64. The elongated body member 62 has a first end 66, a second end 68, a passageway 70 extending there between and an outer peripheral surface 72. The elongated body member 62 is further provided with a first outwardly extending shoulder 74 and a second outwardly extending shoulder 76. The first outwardly extending shoulder 74 is supported on the first end 66 of the elongated body member 62 and the second outwardly extending shoulder 76 is supported on the second end 68 of the elongated body member 62. The first outwardly extending shoulder 74 is disposed a distance from the second outwardly extending shoulder 76 so as to provide a hand grippable portion along the outer peripheral surface 72 of the elongated body member 62. The passageway 70 has a diameter 78.

The thorn removal member 64 is supported by the elongated body member 62 such that the thorn removal member 64 traverses the passageway 70 of the elongated body member 62. The thorn removal member 64 has an opening 80 therein which has a diameter 82 less than the diameter 78 of the passageway 70 of the elongated body member 62, but which is greater in size than the opening 38 in the thorn removal member 20 of the apparatus 10 herein before described with reference to FIGS. 1-3. Thus, the apparatus 60 differs from the apparatus 10 in the size (i.e., the diameter 82) of the opening 80 of the thorn removal member 60 and the position of the thorn removal member 60 within the passageway 70 of the elongated body member 62. It should be noted that the diameters 36 and 82 of the openings 38 and 80 of the thorn removal members 20 and 64, respectively, are shown for illustrative purposes only and the diameters of the openings 38 and 80 will be dependent upon the diameter of the stem 16 of the plant 17 from which thorns 12 and spurious foliage 14 are to be removed via the apparatus 10 or 60. Further, it should be understood that the position of the thorn removal members 20 and 64 of the apparatus 10 and 60 can vary along the length of the passageway 26 and 70 of the elongated body members 18 and 62 of the apparatus 10 and 60, respectively.

The operation of the apparatus 10 and 60 is similar. Thus, only the operation of the apparatus 10 for removing at least the tip portions of the thorns 12 and any spurious foliage 14 from the stem 16 of the plant 17 will be described with reference in FIGS. 1 and 2. To remove at least the tip portions of the thorns 12 and spurious foliage 14 from the stem 16 of the plant 17, an operator grips the elongated body member 18 along the outer peripheral surface 27 of the elongated body member 18 of the apparatus 10 with one hand 90. The operator then grips the stem 16 of the plant 17 near a bloom portion 92 of the plant 17 with the operator's other hand 94 and inserts the stem 16 of the plant 17 into the passageway 26 of the elongated body member 18 while griping the apparatus 10 with hand 90. The operator then moves a portion of the stem 16 of the plant 17 through the passageway 26 of the elongated body member 18 such that a distal end of the stem 16 engages the first surface 42 of the thorn removal member 20 whereby the concave shape of the first surface 42 assists in directing the stem 16 of the plant 17 into the opening 38 in the thorn removal member 20. The operator then moves the stem 16 of the plant 17 in a to and fro direction through the opening 38 in the thorn removal member 20 (as indicated by the arrows 50 and 52). The to and fro movement of the stem 16 of the plant 17 results in removal of at least the tip portions of the thorns 12 and spurious foliage 14 on the portion of the stem 16 being moved through the opening 38 in the thorn removal member 20. The operator then withdraws the stem 16 of the plant 17 from the passageway 26 of the elongated body member 18 of the apparatus 10, thereby providing the plant 17 with at least a portion of the stem 16 of the plant 17 substantially free of at least the tips of the thorns 12 and spurious foliage 14, while preventing damage to the xylem of the plant 17.

From the above description it is clear that the present invention is well adapted to carry out the objects and to attain the advantages mentioned herein as well as those inherent in the invention. While a presently preferred embodiment of the invention has been described for purposes of this disclosure, it will be understood that numerous changes may be made which will readily suggest themselves to those skilled in the art and which are accomplished within the spirit of the invention disclosed and as defined in the appended claims.

What is claimed:

1. An apparatus for removing thorns and foliage from a stem of a plant, comprising:
an elongated body member having a first end, a second end and a passageway extending there through, the passageway having a diameter greater than the diameter of the combination of the stem of the plant and the thorns extending outwardly therefrom; and
a thorn removal member supported by the elongated body member such that the thorn removal member traverses the passageway of the elongated body member, the thorn removal member having an opening therein having a diameter less than the diameter of the passageway of the elongated body member, the opening in the thorn removal member sized and dimensioned to permit passage of the stem of the plant there through while resisting passage of the thorns of the stem of the plant there through so that at least a tip portion of the thorns is removed by the thorn removal member as the stem of the plant is moved in a to and fro direction through the opening in the thorn removal member.

2. The apparatus of claim 1, wherein the elongated body member further comprises:
a first shoulder supported on the first end of the elongated body member so as to extend outwardly therefrom; and
a second shoulder supported on the second end of the elongated body member so as to extend outwardly therefrom, the first shoulder and the second shoulder spatially disposed from one another so as to provide a hand gripping portion on the elongated body member.

3. The apparatus of claim 1, wherein the thorn removal member has a first surface and a second surface, and wherein each of the first and second surfaces has a concave shape.

4. A method of removing thorns and foliage from plant stems comprising the steps of:
providing a thorn removal apparatus, the thorn removal apparatus comprising:
an elongated body member having a first end, a second end and a passageway extending there through, the passageway having a diameter greater than the diameter of the stem of the plant having the thorns extending outwardly therefrom; and
a thorn removal member supported by the elongated body member such that the thorn removal member traverses the passageway of the elongated body member, the thorn removal member having an opening therein having a diameter less than the diameter of the passageway of the elongated body member, the opening in the thorn removal member sized to permit passage of the stem of the plant there through while resisting passage of the thorns of the stem of the plant there through so that at least a tip portion of the thorns is removed by the thorn removal member as the stem;
inserting a plant stem into the passageway of the elongated body member of the apparatus and into the opening of the thorn removal member;
moving the plant in a to and fro direction through the opening in the thorn removal member so as to remove at least the tip portion of the thorns by the thorn removal member as the stem of the plant is moved in a to and fro direction through the opening in the thorn removal member; and
removing the plant from the passageway of the elongated body member whereby at least the tip portion of thorns on at least a portion of the stem have been removed therefrom.

5. The method of claim 4 wherein, in the step of providing the thorn removal apparatus, the elongated body member is provided with a outer peripheral surface, and wherein the method further comprises grasping the elongated body member about the outer peripheral surface with one hand prior to inserting the plant stem into the elongated passageway of the elongated body member.
